(19) United States
(12) Patent Application Publication
(10) Pub. No.: US 2011/0255034 A1
(43) Pub. Date: Oct. 20, 2011

(54) DISPLAY DEVICE

(76) Inventors: Yasushi Nakano, Tokyo (JP); Hitoshi Azuma, Yokohama (JP); Tomio Yaguchi, Sagamihara (JP)

(21) Appl. No.: 13/084,609

(22) Filed: Apr. 12, 2011

(30) Foreign Application Priority Data
Apr. 16, 2010 (JP) JP 2010-095354

(51) Int. Cl. G02F 1/1333; B32B 38/04; C09J 5/02; H01J 1/62; G02F 1/167

(52) U.S. Cl. 349/84; 313/483; 359/296; 156/307.3; 156/250

(57) ABSTRACT

The display device according to the present invention is a display device comprising a thin glass substrate (applied thin glass) and a thin film transistor circuit (TFT circuit layer) formed on the thin glass substrate, wherein the thin glass substrate is gained by forming a transparent resin film (resin thin film) on a support member, applying a glass material to the transparent resin film, baking the glass material, and after that removing the support member.

### CROSS-REFERENCE TO RELATED APPLICATION

The present application claims priority over Japanese Application JP 2010-95354 filed on Apr. 16, 2010, the contents of which are hereby incorporated into this application by reference.

### BACKGROUND OF THE INVENTION

(1) Field of the Invention

The present invention relates to a display device, and in particular to a display device using a thin glass substrate having a thickness of several tens of μm or less.

(2) Description of the Related Art

Various types of display devices, such as liquid crystal modules (liquid crystal display devices) and organic electroluminescent display devices, have been used for many portable information devices, such as cellular phones, personal digital assistants (PDA's), digital cameras and multimedia players.

A transparent substrate made of glass or a resin is used for these display devices. In order to increase the flexibility of a display device, it is necessary to reduce the thickness of the transparent substrate. As shown in FIG. 1, in the case of a glass substrate, the radius of the bent substrate is 15 mm when the thickness is 50 μm while the radius of the bent substrate is approximately 3 mm when the thickness is 10 μm. Flexibility is significantly higher in the latter case.

The methods for reducing the thickness of the transparent substrate include a method for etching the glass substrate, as in JP 2008-39866A, according to which glass substrates having a thickness of 0.5 mm or a thickness of 0.4 mm have inconsistencies in the thickness of approximately +/−10 μm in the case where the glass substrate is large. Therefore, when the thickness is reduced to 50 μm through etching, the difference in the thickness is as large as +/−20%. Accordingly, it is practically difficult to reduce the thickness to less than 50 μm through etching.

Meanwhile, a method for using a resin thin film as the transparent substrate has been proposed in JP 2008-292608A. In the case where thin film transistors (TFT's) are formed directly on the resin thin film, however, the resin thin film thermally expands due to the high temperature during the process for manufacturing TFT's, and thus a problem arises such that the TFT film is wrinkled or cracked, which makes it difficult to put the method into practice.

### SUMMARY OF THE INVENTION

An object to be achieved by the present invention is to solve the above described problem and provide a display device using a thin glass substrate having a thickness of several tens of μm or less.

In order to achieve the above described object, the following are possible.

(1) A display device comprising a thin glass substrate and a thin film transistor circuit formed on the thin glass substrate is characterized in that the thin glass substrate is gained by forming a transparent resin film on a support member, applying a glass material to the transparent resin film, baking the glass material, and after that removing the support member.
(2) The display device according to the above described (1) is characterized in that the display device is any of a liquid crystal display device, an organic electroluminescent display device and an electrophoretic display device.
(3) The display device according to the above described (1) is characterized in that a resin film is pasted to the thin glass substrate on a side where the transparent resin film is provided.
(4) The display device according to the above described (1) is characterized in that a plurality of glass plates is pasted to the thin glass substrate on a side where the transparent resin film is provided.
(5) The display device according to the above described (4) is characterized in that a polarizing plate or a backlight is pasted to a surface of each of the plurality of glass plate.
(6) The display device according to the above described (3) is characterized in that the resin film is completely divided into a plurality of pieces.
(7) The display device according to the above described (3) is characterized in that the resin film has a plurality of first portions and at least one second portion which is thinner than the first portions, and the second portion is disposed between the first portions.
(8) The display device according to any of the above described (1) is characterized in that a color filter is formed either on a side of the thin glass substrate where the thin film transistor circuit is provided or on a resin substrate which faces the thin glass substrate.
(9) The display device according to any of the above described (1) and (6) is characterized in that a light emitting layer is formed of an organic electroluminescent material on a side of the thin glass substrate where the thin film transistor circuit is provided, and a moisture barrier layer is formed on a surface of the light emitting layer.
(10) The display device according to the above described (9) is characterized in that either a resin film or a polarizing film is provided on a surface of the moisture barrier layer.
(11) The display device according to any of the above described (i) is characterized in that the transparent resin film has retardation of 10 nm or less.

According to the present invention, the thin glass substrate is gained by forming a transparent resin film on a support member, applying a glass material to the transparent resin film, baking the applied glass material, and after that removing the support member, and therefore it is possible for the thin glass substrate to be approximately several μm, and thus it is possible to provide a display device having high flexibility where the radius of the bent substrate is as low as several mm. In addition, the glass substrate is not wrinkled or cracked during the process for manufacturing TFT's.

### BRIEF DESCRIPTION OF THE DRAWINGS

FIG. 1 is a graph showing the relationship between the thickness of a glass substrate and the radius of the substrate when bent;

FIG. 2 is a diagram showing an example of a thin glass substrate used in the display device according to the present invention;

FIG. 3 is a diagram showing an example of the display device according to the present invention when used as a liquid crystal display device;

FIG. 4 is a diagram illustrating the manufacturing step (Stage 1) of the display device (liquid crystal display device) according to the present invention;

FIG. 5 is a diagram illustrating the manufacturing step (Stage 2) of the display device (liquid crystal display device) according to the present invention;

FIG. 6 is a diagram illustrating the manufacturing step (Stage 3) of the display device (liquid crystal display device) according to the present invention;

FIG. 7 is a diagram illustrating the manufacturing step (Stage 4) of the display device (liquid crystal display device) according to the present invention;

FIG. 8 is a diagram illustrating the manufacturing step (Stage 5) of the display device (liquid crystal display device) according to the present invention;

FIG. 9 is a diagram showing an example of the display device (liquid crystal display device) according to the present invention where a resin film is provided on one surface;

FIG. 10 is a diagram showing an example of the display device (liquid crystal display device) according to the present invention where a divided glass substrate is provided on one surface;

FIG. 11 is a diagram showing an example of the display device that is the same as in FIG. 10 to which a polarizing plate and a backlight are provided;

FIG. 12 is a diagram showing an example of the display device (liquid crystal display device) according to the present invention where a divided resin film is provided on one surface;

FIG. 13 is a diagram showing an example of the display device (liquid crystal display device) according to the present invention where a resin film of which the thickness is locally thin is provided on one surface;

FIG. 14 is a diagram showing an arrangement of the color filter in the display device (liquid crystal display device) according to the present invention;

FIG. 15 is a diagram showing another arrangement of the color filter in the display device (liquid crystal display device) according to the present invention;

FIG. 16 is a diagram showing an example of the display device according to the present invention when used as an organic electroluminescent display device;

FIG. 17 is a diagram showing an example of the display device that is the same as in FIG. 16 to which a resin film and a polarizing plate are pasted; and

FIG. 18 is a diagram showing an example of the display device that is the same as in FIG. 16 where a resin film that is locally thin is arranged on one surface.

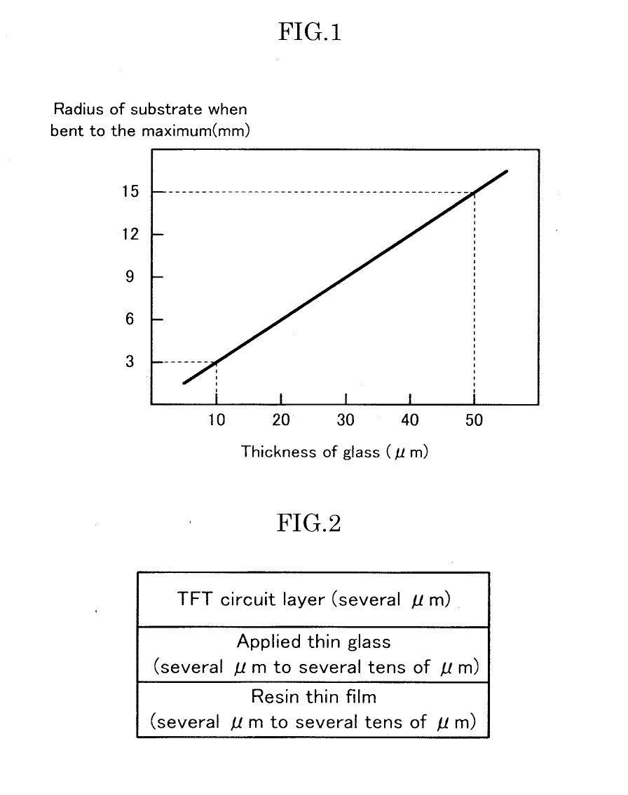

### DESCRIPTION OF THE EMBODIMENTS

The display device according to the present invention is described in detail below. FIG. 2 shows a thin glass substrate used in the display device according to the present invention.

The display device according to the present invention is a display device where a thin film transistor circuit (TFT circuit layer) is formed on a thin glass substrate as that shown in FIG. 2, which is characterized in that the thin glass substrate is gained by forming a transparent resin film (resin thin film) on a support member, applying a glass material to the transparent resin film, baking the applied glass material, and after that removing the support member.

The thickness of the applied thin glass, which is a thin glass substrate, can be set to several gm to several tens of μm, and therefore it is possible for the radius of the substrate when bent to be several mm. In addition, the thin glass substrate basically has only a TFT circuit layer having a thickness of several μm and a resin thin film having a thickness of approximately several μm to several tens of μm attached thereto, and therefore it is possible to provide a glass substrate having a TFT circuit that is highly flexible and almost as flexible as the thin glass substrate.

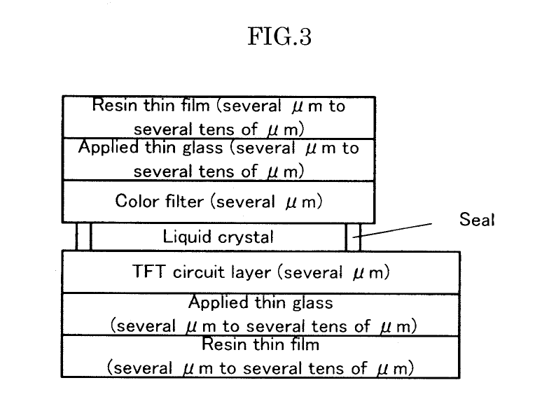

FIG. 3 is a diagram showing the structure of a liquid crystal display panel using the thin glass substrate (applied thin glass) of FIG. 2. A TFT circuit layer is formed on the thin glass substrate (applied thin glass) on the bottom side, and a color filter is formed on the thin glass substrate (applied thin glass) on the top side. A liquid crystal layer is formed in such a way as to be sandwiched between the two glass substrates and sealed by the sealing member. The TFT circuit layer and the color filter naturally have a liquid crystal alignment film, not shown, formed on the surface.

Thus, the two transparent substrates that form a liquid crystal display panel are formed of thin glass substrates (applied thin glass) as in the present invention, and as a result it becomes possible for the liquid crystal display device to be significantly more flexible than the conventional liquid crystal display devices using glass substrates having a thickness of approximately 50 μm.

The display device using a thin glass substrate according to the present invention is not limited to the liquid crystal display device as in FIG. 3, but it is possible for the invention to be applied to an organic electroluminescent display device or an electrophoretic display device as described below.

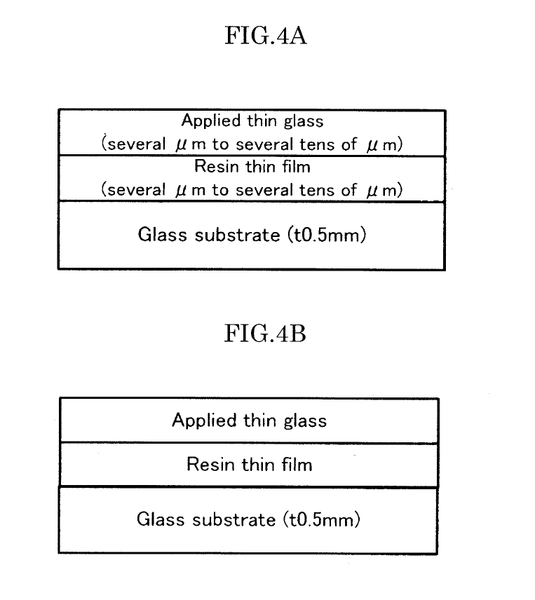

FIGS. 4A to 8 are diagrams illustrating the process for manufacturing the liquid crystal display device of FIG. 3. Two thin glass substrates (applied thin glass), as shown in FIGS. 4A and 4B, are prepared. The substrate in FIG. 4A functions as a substrate for forming a color filter and the substrate in FIG. 4B functions as a substrate on which a TFT circuit is provided.

The substrates, as shown in FIGS. 4A and 4B, are formed by preparing a glass substrate having a thickness of approximately 0.5 mm and forming a transparent resin film on the glass substrate through the spin coating or line coating of a polyimide-based, highly heat resisting resin, for example. The thickness of this resin thin film is approximately several μm to several tens of μm. It is preferable for the transparent resin film to be able to resist heat at a temperature of approximately 250° C. to 350° C. In addition, it is preferable for the transparent resin film to have retardation (Δn (birefringence)×d (film thickness)) of 10 nm or less, taking increase in the contrast into consideration.

Next, a glass material is applied to the resin thin film through spin coating or line coating, and the applied glass material is baked at a temperature of no higher than the temperature at which the transparent resin film (resin thin film) can resist heat, and thus a thin glass substrate (applied thin glass) having a thickness of several μm to several tens of μm is formed. Polysilazane and the like can be used as the glass material to be applied.

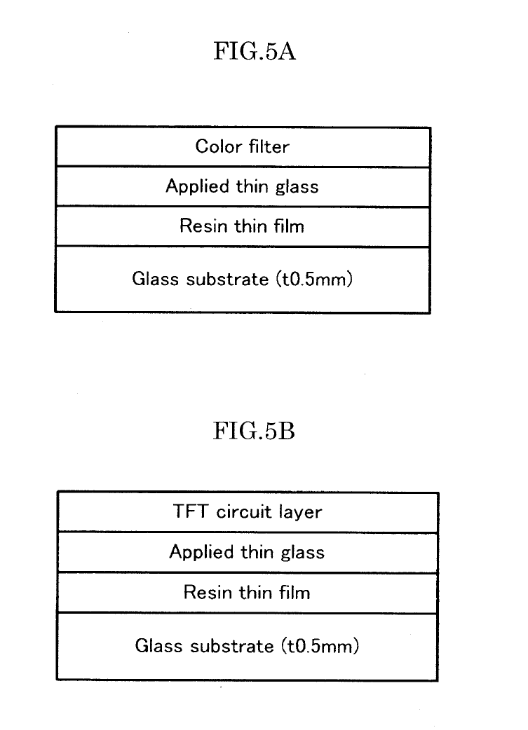

In FIG. 5A, a color filter is formed on the surface of the applied thin glass, and in FIG. 5B, a TFT circuit layer is formed on the surface of the applied thin glass. In particular, a TFT circuit is formed on the thin glass substrate (applied thin glass) according to the present invention, and therefore wrinkling and cracking can be prevented during the process for manufacturing TFT's, unlike in the conventional resin thin films.

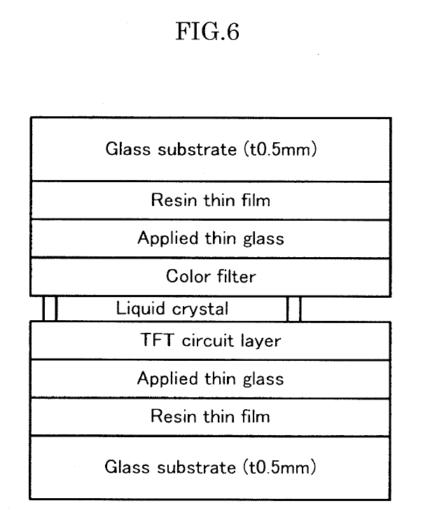

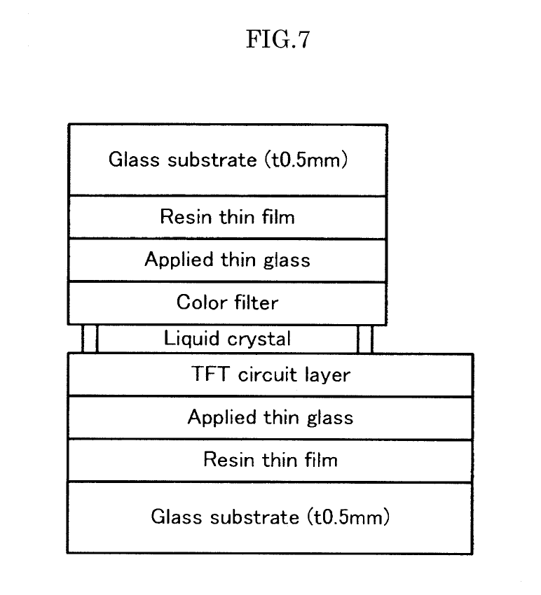

Next, as shown in FIG. 6, the substrates are placed so as to seal the liquid crystal in between with the color filter and the TFT circuit facing each other. After the two substrates are pasted together, the two substrates are cut at the same time into individual display devices of which the form is modified, as shown in FIG. 7. A semiconductor chip for driving the TFT circuit and power supply lines using a flexible printed circuit (FPC) are usually arranged on the substrate with the TFT circuit, and therefore the substrate with the TFT circuit is larger than the substrate with the color filter.

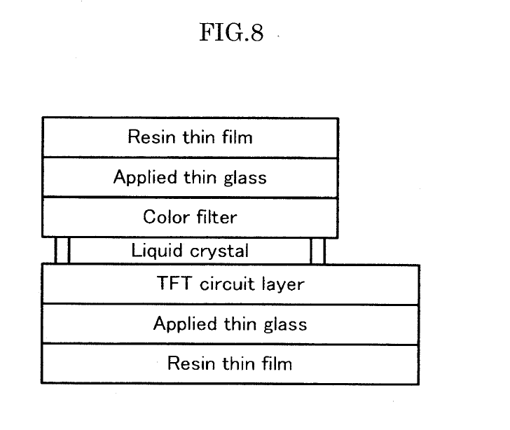

The liquid crystal display device is irradiated with an ultraviolet laser through the glass substrates so that the interface between the glass substrates having a thickness of 0.5 mm and the transparent resin films (resin thin films) is modified, and thus the glass substrates are peeled from the transparent resin films and a thin liquid crystal display panel is formed, as shown in FIG. 8. Though in the above description the glass substrates are peeled after the substrates have been cut into pieces, as in FIG. 7, it is also possible to cut the substrates, including a thin glass substrate (applied thin glass), after the glass substrates have been peeled.

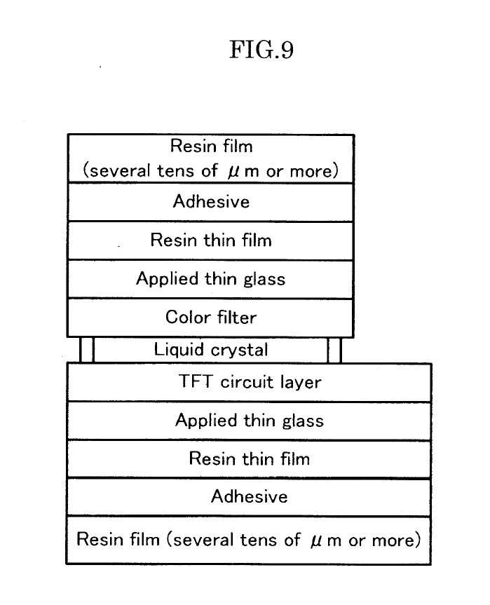

In the display device according to the present invention, as shown in FIG. 9, it is possible to paste resin films having a thickness of several tens of μm to the top and bottom of the display panel with an adhesive in order to increase the mechanical strength of the display panel. Though a birefringent film cannot be used in liquid crystal display devices, it is possible to use a birefringent film, such as of PET or polycarbonate, in organic electroluminescent display devices.

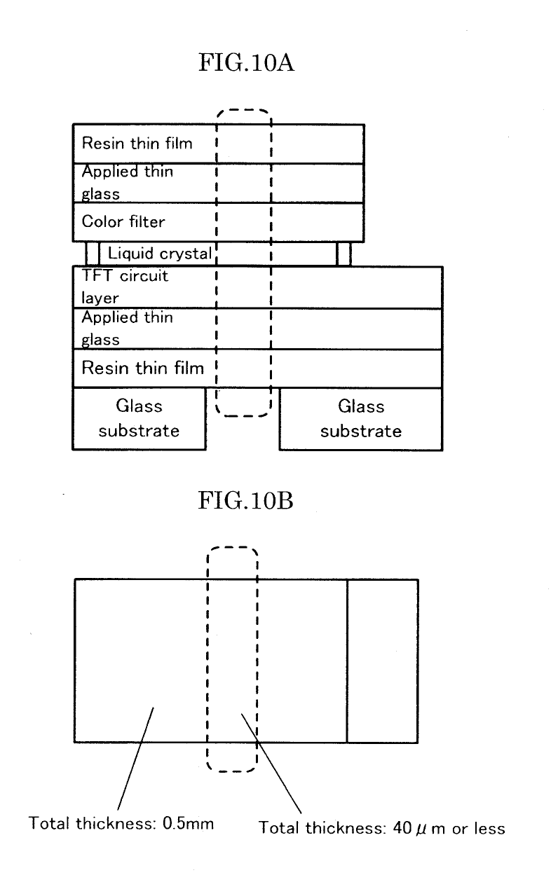

FIGS. 10A to 13 show an example of a foldable display device.

In FIGS. 10A and 10B, a number of glass plates (glass substrates) in the same plane are pasted to the thin glass substrates (applied thin glass) on the side where a transparent resin film (resin thin film) is provided in order to increase the mechanical strength. FIG. 10A is a cross sectional diagram showing the display panel, and FIG. 10B is a plan diagram showing the display panel. The thickness of the portions to which a glass substrate is pasted is approximately 0.5 mm while the thickness of the portion surrounded by the dotted line to which a glass substrate is not pasted is 40 μm or less, and thus the display device can be folded along this dotted line portion.

Though the reinforcing glass substrate is pasted to the thin glass substrate with the TFT circuit in FIGS. 10A and 10B, it is also possible to paste the reinforcing glass substrate to the thin glass substrate (applied thin glass) with the color filter. In addition, the thickness of the upper and lower applied thin glass is adjusted so that the TFT film is located at the center when the display panel is bent.

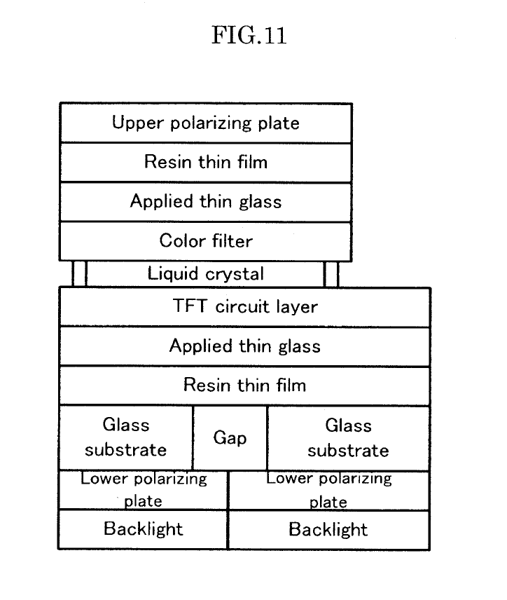

FIG. 11 shows a display device where upper and lower polarizing plates and backlights are provided to the liquid crystal display panel of FIG. 10. In the case where it is difficult to fold the liquid crystal display panel, the polarizing plates and the backlights are divided in the area along which the glass substrate is divided, as shown in the bottom portion of FIG. 11. Here, it is desirable for the optical films for the backlights and the aperture ratio of the TFT pixels to be designed such that the bent portion does not make the brightness inconsistent.

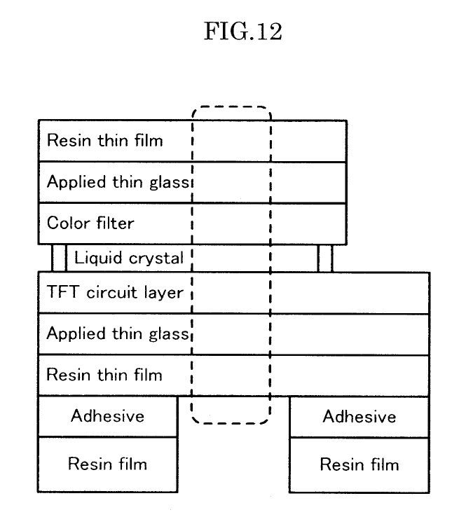

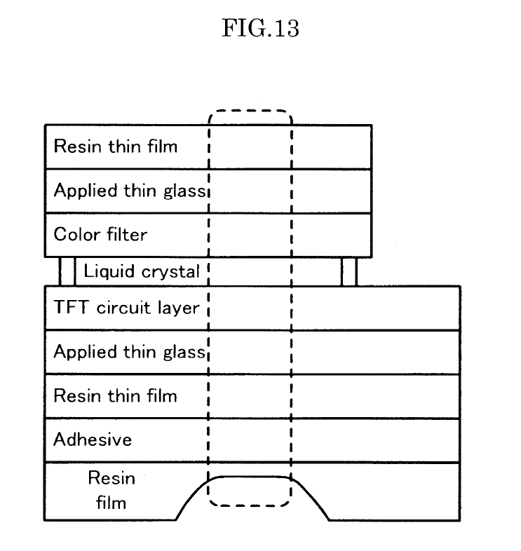

In FIG. 12, a display device where a resin film is used as a reinforcing member and the resin film is divided along the portion along which the display device can be folded is proposed. Here, as shown in FIG. 13, it is possible for the display device to be foldable along the dotted line portion where a portion of the resin film is thin.

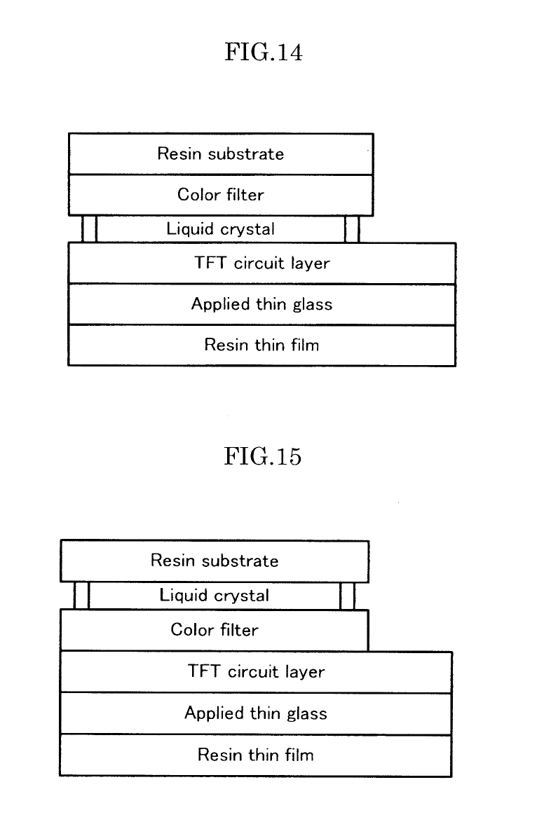

FIGS. 14 and 15 show embodiments where the arrangements of the color filter and the like have been changed. In FIG. 14, the color filter is held by the resin substrate instead of the applied thin glass. In FIG. 15, the color filter is placed on the upper surface of the TFT circuit layer. Needless to say, various modifications are possible on the basis of the type of liquid crystal display device such that all the electrodes are provided on the TFT circuit side, and the common electrode is provided on the substrate with the color filter of FIG. 3.

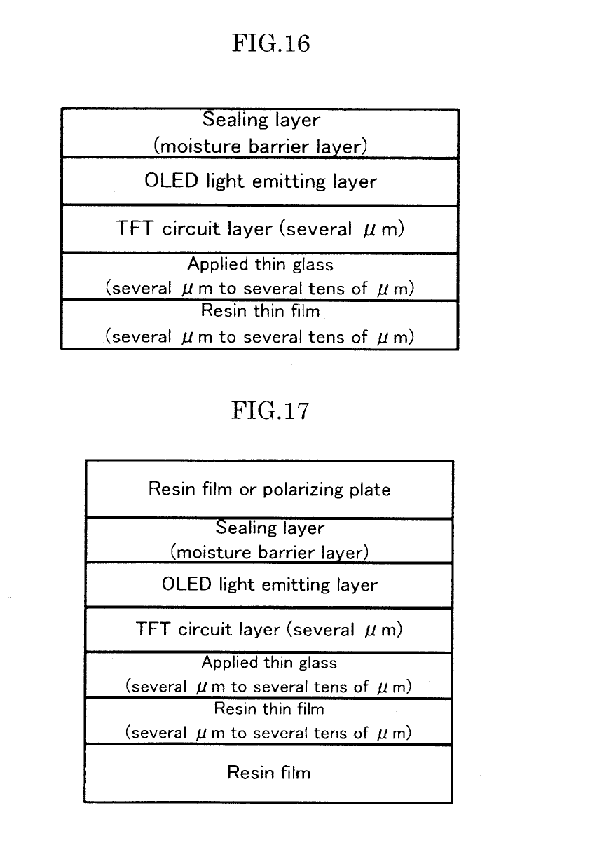

FIGS. 16 to 18 show examples of organic electroluminescent display devices.

The TFT circuit layer is formed on the surface of the applied thin glass, which is a thin glass substrate, and furthermore an organic electroluminescent light-emitting layer is formed. The properties of the organic electroluminescent material deteriorate due to moisture, and therefore a moisture barrier layer is formed on the upper surface of the light-emitting layer as a sealing layer. The thin glass substrate (applied thin glass) functions as a moisture barrier film on the bottom side of the light-emitting layer.

If necessary, it is also possible to paste a resin film, as in FIG. 17, in order to increase the mechanical strength. In addition, it is possible to provide a polarizing plate on the upper surface of the light-emitting layer.

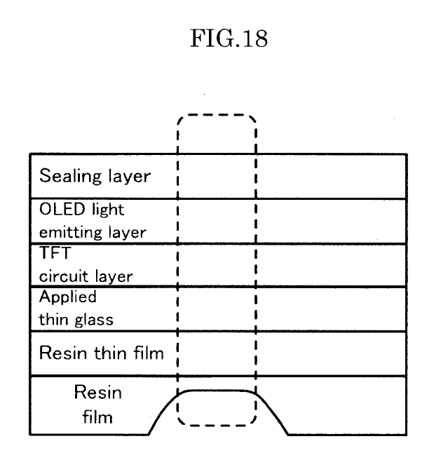

It is possible for the resin film to be partially thin in the organic electroluminescent display device, as in the above described liquid crystal display device, so that the display device can be folded along the dotted line portion in FIG. 18.

### INDUSTRIAL APPLICABILITY

As described above, it is possible for the present invention to provide a display device using a thin glass substrate having a thickness of several tens of μm or less.

What is claimed is:

1. A display device comprising a thin glass substrate and a thin film transistor circuit formed on the thin glass substrate, characterized in that
the thin glass substrate is gained by forming a transparent resin film on a support member, applying a glass material to the transparent resin film, baking the glass material, and after that removing the support member.

2. The display device according to claim 1, characterized in that the display device is any of a liquid crystal display device, an organic electroluminescent display device and an electrophoretic display device.

3. The display device according to claim 1, characterized in that a resin film is pasted to the thin glass substrate on a side where the transparent resin film is provided.

4. The display device according to claim 1, characterized in that a plurality of glass plates are pasted to the thin glass substrate on a side where the transparent resin film is provided.

5. The display device according to claim 4, characterized in that a polarizing plate or a backlight is pasted to a surface of each of the plurality of glass plate.

6. The display device according to claim 3, characterized in that the resin film is divided into a plurality of pieces.

7. The display device according to claim 3, characterized in that the resin film has a plurality of first portions and at least one second portion which is thinner than the first portions,
wherein the second portion is disposed between the first portions.

8. The display device according to claim 1, characterized in that a color filter is formed either on a side of the thin glass substrate where the thin film transistor circuit is provided or on a resin substrate which faces the thin glass substrate.

9. The display device according to claim 1, characterized in that a light emitting layer is formed of an organic electroluminescent material on a side of the thin glass substrate where the thin film transistor circuit is provided, and a moisture barrier layer is formed on a surface of the light emitting layer.

10. The display device according to claim 9, characterized in that either a resin film or a polarizing film is provided on a surface of the moisture barrier layer.

11. The display device according to claim 1, characterized in that the transparent resin film has retardation of 10 nm or less.
